(19) United States
(12) Patent Application Publication
(10) Pub. No.: US 2023/0116220 A1
(43) Pub. Date: Apr. 13, 2023

(54) Coating Device for Moistening a Flat Substrate

(71) Applicant: Contiweb B.V., Boxmeer (NL)

(72) Inventor: Clemens Johannes Maria De Vroome, Boxmeer (NL)

(21) Appl. No.: 17/802,708

(22) PCT Filed: Mar. 8, 2021
(86) PCT No.: PCT/IB2021/051914

§ 371 Date: Aug. 26, 2022

(30) Foreign Application Priority Data
Mar. 9, 2020 (NL) 2025086

(51) Int. Cl. B05C 1/08; B41F 23/02

(52) U.S. Cl. CPC B05C 1/0808; B41F 23/02

(57) ABSTRACT

A coating device for moistening a flat substrate, particularly a paper web, comprising a liquid bath which is in contact with the liquid to be applied and a coating roller which is in contact with the liquid in order to take up a quantity thereof and transfer it to the substrate. The coating roller comprises a cylinder body having at a periphery thereof a cylinder surface which is covered with an absorption layer which is able and configured to take up liquid from the liquid bath and supply it to the substrate.

The present invention relates to a coating device for moistening an at least substantially flat substrate, particularly a paper web, comprising a liquid bath intended and configured to hold a liquid, comprising a coating roller which is configured to enter into contact with the liquid in the liquid bath in order to take up a quantity thereof and transfer it at least partially to the substrate, and comprising means for bringing the substrate into contact with the coating roller.

Such a coating device is for instance known from patent no. 2.222.473 of applicant which was granted in Europe, and is applied particularly in a printing facility for moistening or remoistening printed material. The printed material is preferably formed by a continuous paper web as substrate in a continuous printing process. The substrate is unwound from a roll of paper and guided through a printing line so as to be printed with one or more inks, after which the printed paper is then dried in a minimal amount of time at increased temperature. Not only is/are the ink(s) used dried here however, moisture is inevitably also extracted from the paper. In order to counter an uncontrolled re-absorption of water by the paper as soon as the completed printing material is exposed to the environment, the paper is preferably remoistened in order to restore the natural moisture balance thereof and to adapt the moisture content to a prevailing air humidity. An aqueous silicone suspension is particularly applied here in order to furthermore counter sticking and adhesion of the printing ink used.

In such a coating device it is a challenge to deposit the liquid uniformly on the substrate. For this purpose the known coating device comprises a coating roller which is driven counter to a web direction of the substrate. A quantity of liquid taken up from the liquid bath by the coating roller is thus spread over the substrate so as to form a thin layer thereon. The coating roller of the known coating device comprises here a cylinder body with a peripheral surface which is coated with a teflon layer. Due to a dragging contact with the substrate web, this plastic layer becomes electrostatically charged, whereby the liquid from the liquid bath is attracted despite the naturally hydrophobic plastic which is used. On the substrate the wet, electrostatically charged surface provides for a corona discharge to the substrate, wherein the liquid is spread over the substrate surface in finely distributed manner.

Although the known device provides hereby a significant step towards a uniform spreading of a liquid to be applied over the substrate by means of such a coating roller which is in direct contact with the liquid in the liquid bath, there is nevertheless room for improvement. The relatively soft plastic top layer of the cylinder body is moreover relatively susceptible to wear as a result of friction with the substrate. Changing over a worn coating roller of the known device is relatively time-consuming, during which time the printing line is out of operation.

The present invention has for its object, among others, to provide a coating device which provides for a relatively uniform deposition of the liquid on the substrate and which need only be taken out of operation for a relatively short time when a contact surface thereof becomes worn.

In order to achieve the stated object a coating device of the type described in the preamble has the feature according to the invention that the coating roller comprises a cylinder body having at a periphery thereof a cylinder surface which is covered with a compressible absorption layer which is able and configured to take up liquid from the liquid bath and, when in contact with the substrate, supply the liquid to the substrate. Other than in the known device, the taken-up liquid does not so much take the form of a continuous film on the surface of the coating roller, but according to the invention the liquid is taken up at least partially by the absorbent absorption layer and, when in sliding contact with the substrate, supplied to the surface thereof.

In this respect an absorption layer is understood to mean a layer having the ability to absorb therein and then supply the stated liquid. This is particularly a compressible absorption layer which for the purpose of the intended supplying of liquid is squeezed a little in the case of a mutual contact pressure between the absorption layer and the substrate. It has been found in practice that a significantly more uniform coverage of the substrate can be achieved thereby than with the known device. The cylinder surface particularly forms a periphery of the coating roller and is particularly a closed cylinder surface.

It is otherwise noted that it is per se known from American patent USP 4.675.220 to cover a transfer roller in an offset printing press with a textile shrinking sleeve. This is however a sleeve which is applied as damping between successive rollers of a roller assembly, wherein water is transferred by a roller covered with the sleeve to a smooth cylinder. The sleeve thus does not come into contact with the flat paper substrate.

Although various materials can per se be applied for the absorption layer within the scope of the invention, a particular embodiment of the coating device has the feature according to the invention that the absorption layer comprises a cloth, particularly a textile cloth, which is removable from the cylinder surface and can be exchanged. Although such a relatively soft, and partly as a result thereof less wear-resistant, textile will be subject to wear during operation, replacement only requires a change-over of the cloth, which can be performed in a relatively short amount of time. The device being taken out of operation can thus be limited to a minimum. This is particularly the case in a preferred embodiment of the coating device which is characterized according to the invention in that the cloth is formed by a sleeve which is open on opposite sides and with which the cylinder body is covered.

A further particular embodiment of the coating device is characterized in the latter respect in that the sleeve can be stretched elastically from a rest state with a smaller diameter than the cylinder body to a stretched state in which the sleeve lies against the cylinder surface of the cylinder body under tension. In an alternative embodiment the coating device is characterized in that the sleeve comprises a shrinking sleeve which can be shrunk from a rest state with at least the same cross-section as the cylinder body to a shrunken state in which the sleeve lies against the cylinder surface of the cylinder body under tension. Such stretched sleeves provide the advantage that they can be easily arranged and adapt themselves to the specific diameter of the coating roller within a relatively wide elastic or shrink range. The dimensioning is thereby not very critical, at least in diameter, while the sleeve can be shortened to size in axial direction if desired.

A friction layer (anti-slip) can optionally be provided inside such an elastic or shrinking sleeve in order to prevent radial shifting and twisting over the cylinder surface. With a view thereto, mutually complementary profilings can also be applied between the inner side of the sleeve and the cylinder surface. For the purpose of an axial fixation of the sleeve on the cylinder surface a mechanical fastening can optionally be applied at the end surfaces, for instance by means of tie wraps, cords or the like, whereby the sleeve is clamped firmly onto the cylinder surface.

Various types of textile are suitable for the textile sleeve. Particularly good results have however been achieved with a particular embodiment of the coating device according to the invention, characterized in that the cloth comprises a microfibre textile, particularly of polymer microfibres.

Instead of a textile, other absorbent compositions in the form of such an absorbent sleeve can also be applied, wherein the absorption into the material can take place on both a hydrophilic and a capillary basis. A further particular embodiment of the coating device according to the invention has the feature in this respect that the coating roller comprises a porous top layer. A further particular embodiment of the coating device has the feature that the absorption layer comprises a foamed layer, more particularly of a polymer foam with an open cell structure.

The invention also relates to a jacket for application in or with the coating device according to the invention, comprising a sleeve which is open on opposite outer ends and has an absorbent surface on an outer side thereof. In a preferred embodiment such a jacket here has the feature according to the invention that the sleeve comprises an elastic textile, particularly an elastic microfibre cloth, and can be stretched round the coating roller.

The invention will be further elucidated hereinbelow with reference to an exemplary embodiment and an accompanying drawing. In the drawing:

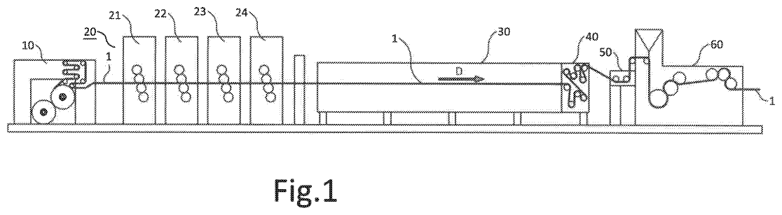

FIG. 1 shows a schematic representation of a production line in a printing facility with a coating device according to the invention therein;

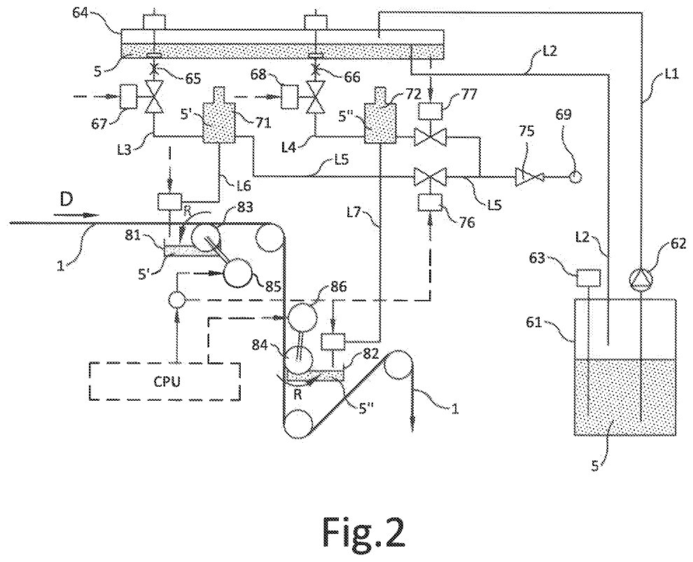

FIG. 2 shows a schematic representation of an exemplary embodiment of a coating device according to the invention as applicable in the production line of FIG. 1;

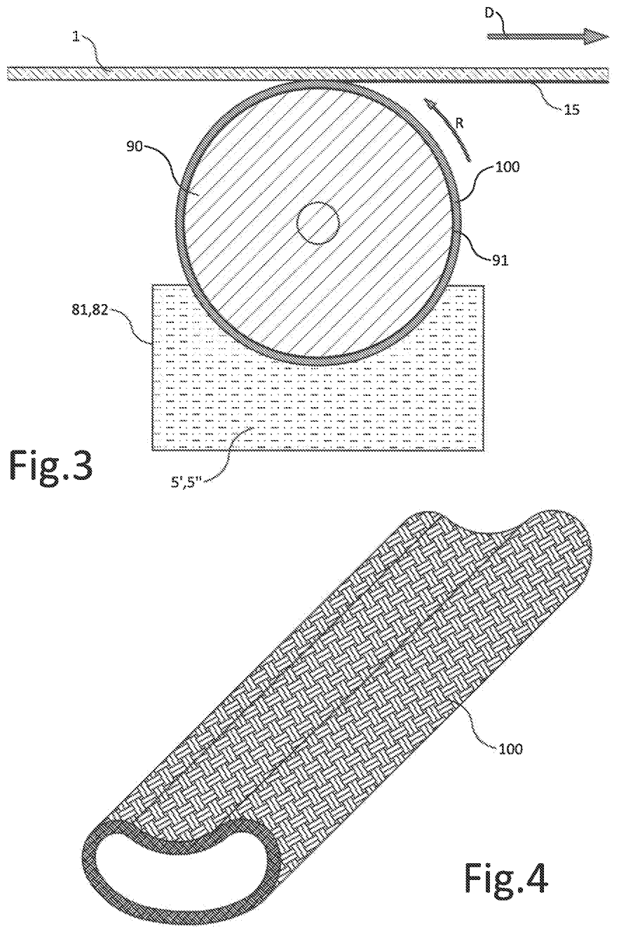

FIG. 3 shows a cross-section of a coating roller as applied in the coating device of FIG. 2;

FIG. 4 shows schematically a jacket for application with the coating roller of FIG. 3;

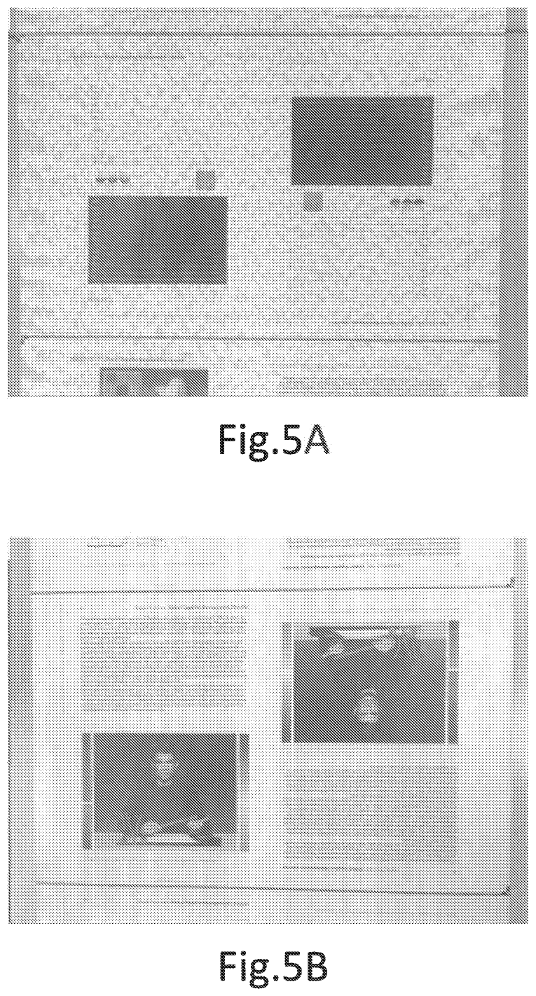

FIG. 5A shows a photographic moistening image, making use of an existing moistening device; and

FIG. 5B shows a photographic moistening image, making use of a moistening device according to the invention.

It is otherwise noted here that the figures are purely schematic and not always drawn to (the same) scale. Some dimensions in particular may be exaggerated to greater or lesser extent for the sake of clarity. Corresponding parts are designated in the figures with the same reference numeral.

FIG. 1 shows a typical example of an offset printing press with web feed, wherein a coating device according to the invention is applied as remoistening device. The shown printing press line comprises successively a roll changer 10, four printing units 21-24, a web receiver 30, a hot-air dryer 40, a cooling roller assembly 50 and the remoistening device 60. The printing press line 2 is provided with per se known means for taking off a paper web 1 from the roll changer 10 and guiding it at a considerable web speed in a transport direction D in a continuous process through the printing units 20, web receiver 30, hot-air dryer 40, cooling roller assembly 50 and remoistening device 60 to an outlet 70 where a finishing unit (not further shown), such as for instance a cutting and folding unit, optionally brings the printing material into its finished form.

The moistening device 60 is shown in further detail in FIG. 2 and serves to apply a suitable moistening liquid to the just dried and at least partially cooled paper web 1. In this embodiment a water-silicone emulsion is applied as moistening liquid therefor. In this embodiment the liquid to be applied is custom-formulated and custom-mixed as desired from individual components in and by the device. For this purpose the moistening device 60 comprises a supply container 61 filled with silicone oil 5, and a fixed water connection 69. Use can instead however also be made in the device of a pre-mixed liquid or a directly commercially available ready-made product, in which case the part of the installation concerned with the mixing of components can be dispensed with.

Supply container 61 comprises a sufficient quantity of silicone oil concentrate 5 for at least one whole print job, so that it will only very rarely be necessary to replace or replenish the container 61 during a print run. This can then for instance be carried out between successive print jobs. Container 61 can for instance take the form of a supply reservoir which is removable and can therefore be exchanged in simple and rapid manner. It is advantageous to thus hold a silicone oil concentrate instead of the ready-made silicone oil-water suspension, because a smaller supply container 61 can thus be used, whereby device 60 can be more compact.

Supply container 61 is connected via a supply conduit L1 to a buffer container 64 and supplies a buffer quantity of the silicone oil 5 thereto. The conduit L1 has a pump 62 which for this purpose transports the silicone oil concentrate 5 from supply container 61 to buffer container 64 in the desired quantity. Buffer container 64 is also connected via an overflow conduit L2 to supply container 61 so that an excess of silicone concentrate 5 can optionally flow back to supply container 61. In this way a constant filling level is maintained in buffer container 64 as long as the supply container contains sufficient silicone oil 5, which is thus carried to buffer container 64 continuously, semi-continuously or at intervals by means of the pump 62.

The supply container 61 can be provided with a sensor-controlled monitoring device 63 which monitors a filling level of supply container 61 and, when a lowest filling level is approached, generates a warning signal to an operator and/or a control unit CPU which also monitors and controls the other process in the moistening device. It is then also possible to switch to a second or further supply container (not shown) automatically when this lowest filling level is reached.

Silicone oil is carried from buffer container 64 via a set of separate supply conduits L3, L4 to two mixing containers 71, 72. Accommodated in each of the supply conduits L3, L4 is a flow limiter 65, 66 together with a valve 67, 68 which is electrically controllable by the control unit CPU, for instance a magnetic valve with an actuator solenoid. An individually controlled quantity of silicone oil can be dosed to each of the mixing containers 71 or 72 by controlled opening of a valve 67 or 68. The flow limiter 65, 66 provides here for a constant and therefore known flow speed of the silicone oil 5, irrespective of a viscosity thereof.

In the mixing containers 71, 72 the silicone oil concentrate 5 is mixed with a second liquid, for which water is in this case used to form an accurately dosed aqueous silicone oil suspension 5′,S″ which will serve as moistening liquid for the paper web 1. The water supply is provided for from the fixed water connection 69 via a supply conduit L5 provided for this purpose, wherein a pressure control valve 75 brings the original water pressure to a defined level. The water pressure is thus kept constant by the pressure control valve 75 so that a constant inlet pressure prevails on an inlet side of a set of calibrated valves 76, 77.

Valves 76, 77 are electronically controlled by a control unit CPU and comprise for instance magnetic valves with an actuator solenoid whereby a throughflow can be increased, throttled or interrupted by energizing the solenoid to greater or lesser extent on the basis of an electronic control signal. Owing to the combination of the pressure control valve 75 and the calibrated valves 76, 77 the water flow (quantity per time) to each of the mixing containers 71, 72 can be accurately controlled and adjusted by the control unit CPU. In each of the mixing containers 71, 72 a specific silicone/water ratio of a silicone oil-water emulsion 5′,5″ to be mixed therein can thus be dosed and adjusted individually, adapted here to the side of the paper 1 to be moistened.

The thus prepared aqueous silicone emulsion 5′,5″ serves to remoisten the paper web, not only the ink of which has been dried in dryer 40, but the natural moisture balance of which has inevitably also been disrupted therein. For this purpose coating device 60 comprises two coating units 90 for moistening paper web 1 on either side. A system of exchangeable rollers 69 brings paper web 1 into contact with coating units 90 successively on both sides. Each of the coating units 90 comprises a liquid bath 81, 82 which is fed from one of the mixing containers 71, 72 via its own supply conduit L6, L7. Each coating unit 90 further comprises a coating roller 83, 84 which is suspended rotatably about a central axis thereof.

The coating rollers 83, 84 are each immersed at least partially in the relevant liquid bath 81, 82 and are driven during operation by means of an electric motor 85, 86 coupled thereto and controllable by the control unit CPU. Each of the coating rollers 83, 84 is able to take up and carry along a quantity of the liquid 5′, 5″ from the liquid bath 81, 82 during rotation. On an opposite side the same coating roller 83, 84 is in sliding contact with paper web 1, to which the liquid 5′, 5″ carried along will then be supplied at least partially. In the embodiment the two rollers 83, 84 are driven counter to the transport direction D of the paper web about their central axis, as indicated with an arrow R, which brings about a dragging contact with paper web 1.

FIG. 3 shows a coating unit 90 of coating device 60 in further detail. Each of the coating rollers 83, 84 comprises a cylinder body 90, for instance of chrome steel, with a closed cylinder surface 91 at the periphery thereof. According to the invention, cylinder surface 91 is covered with a compressible absorption layer 100. This absorption layer is able and configured to take up the liquid 5′, 5″ from liquid bath 81, 82 and supplies the liquid 5′, 5″ at least partially in the form of a coating 15 to paper web 1 upon contact therewith. For absorption layer 100 use is in this case made of an elastic sleeve of microfibre textile, see also FIG. 4. This is slid as a separate jacket over cylinder surface 91 and lies stretched tautly thereon owing to its elasticity.

A friction layer (anti-slip) can optionally be provided inside sleeve 100 in order to prevent radial shifting and twisting over cylinder surface 91. With a view thereto, mutually complementary profilings can also be applied between the inner side of sleeve 100 and cylinder surface 91. For the purpose of an axial fixation of the sleeve on the cylinder surface a mechanical fastening can optionally be applied at the end surfaces, for instance by means of tie wraps, cords or the like, whereby the sleeve is clamped firmly onto the cylinder surface.

It has been found that such a moisture take-up and supply to substrate 1 by coating roller 83, 84 takes place considerably more uniformly and evenly than in the known coating device, wherein the liquid is carried along as a continuous film and is as it were spread onto the substrate. This is further shown in FIGS. 5A and 5B. FIG. 5A shows here a moistening image, wherein use has been made of a coloured liquid and an existing moistening device, while FIG. 5B shows the image if use was made of the above described moistening device according to the invention. In the first image 5A the applied liquid manifests as an irregular, cloudy structure and the paper has been found to cockle. In the latter image the coloured liquid is distributed considerably more uniformly over the surface of the paper than the image shown in FIG. 5A, as indication that the liquid has been applied more uniformly, and the paper remains nicely flat.

Although the invention has been further elucidated above with reference to only a single exemplary embodiment, it will be apparent that the invention is by no means limited thereto. On the contrary, many variations and embodiments are still possible within the scope of the invention for a person with ordinary skill in the art.

In the embodiment use has thus been made of a microfibre cloth, but other absorbent compositions can also be applied for the absorption layer, such as, besides other types of textile, for instance also foamed layers with an open cell structure, particularly polymer foams, and other porous layers. Besides being used with a continuous paper web, the coating device can also be used for sheets of paper or cardboard.

Instead of an elastic sleeve, a shrinking sleeve can also be applied as jacket for the coating roller. Such a shrinking sleeve deforms naturally, for instance when heated or moistened, as a result of a specific fabric composition thereof, and here takes on a shrunken final state wherein the sleeve lies tightly and under tension against the cylinder surface. Besides being provided in the form of an easily exchangeable sleeve, as shown in FIG. 4, the absorption layer can also be provided as a fixed part of the coating roller and in that case be glued, stuck or otherwise adhered to the cylinder surface.

1. Coating device for moistening an at least substantially flat substrate, particularly a paper web, comprising a liquid bath intended and configured to hold a liquid, comprising a coating roller which is configured to enter into contact with the liquid in the liquid bath in order to take up a quantity thereof and transfer it at least partially to the substrate, and comprising means for bringing the substrate into contact with the coating roller, wherein the coating roller comprises a cylinder body having at a periphery thereof a cylinder surface which is covered with a compressible absorption layer which is able and configured to take up liquid from the liquid bath and, when in contact with the substrate, supply the liquid to the substrate.

2. Coating device according to claim 1, wherein the absorption layer comprises a cloth, particularly a textile cloth, which is removable from the cylinder surface and can be exchanged.

3. Coating device according to claim 2, wherein the cloth comprises a microfibre textile, particularly of polymer microfibres.

4. Coating device according to claim 2, wherein the cloth is formed by a sleeve which is open on opposite sides and with which the cylinder body is covered.

5. Coating device according to claim 4, wherein the sleeve can be stretched elastically from a rest state with a smaller diameter than the cylinder body to a stretched state in which the sleeve lies against the cylinder surface of the cylinder body under tension.

6. Coating device according to claim 4, wherein the sleeve comprises a shrinking sleeve which can be shrunk from a rest state with at least the same cross-section as the cylinder body to a shrunken state in which the sleeve lies against the cylinder surface of the cylinder body under tension.

7. Coating device according to claim 1, wherein the absorption layer comprises a porous layer.

8. Coating device according to claim 1, wherein the absorption layer comprises a foamed layer, particularly of a polymer foam with an open cell structure.

9. Jacket for application in the coating roller of the coating device according to claim 1, comprising a sleeve which is open on opposite outer ends and has an absorbent surface on an outer side thereof.

10. Jacket according to claim 9, wherein the sleeve comprises a textile, particularly an elastic microfibre cloth, and can be stretched round the coating roller.

11. Coating device according to claim 3, wherein the cloth is formed by a sleeve which is open on opposite sides and with which the cylinder body is covered.

12. Jacket for application in the coating roller of the coating device according to claim 2, comprising a sleeve which is open on opposite outer ends and has an absorbent surface on an outer side thereof.

13. Jacket for application in the coating roller of the coating device according to claim 3, comprising a sleeve which is open on opposite outer ends and has an absorbent surface on an outer side thereof.

14. Jacket for application in the coating roller of the coating device according to claim 4, comprising a sleeve which is open on opposite outer ends and has an absorbent surface on an outer side thereof.

15. Jacket for application in the coating roller of the coating device according to claim 5, comprising a sleeve which is open on opposite outer ends and has an absorbent surface on an outer side thereof.

16. Jacket for application in the coating roller of the coating device according to claim 6, comprising a sleeve which is open on opposite outer ends and has an absorbent surface on an outer side thereof.

17. Jacket for application in the coating roller of the coating device according to claim 7, comprising a sleeve which is open on opposite outer ends and has an absorbent surface on an outer side thereof.

18. Jacket for application in the coating roller of the coating device according to claim 8, comprising a sleeve which is open on opposite outer ends and has an absorbent surface on an outer side thereof.

19. Jacket for application in the coating roller of the coating device according to claim 9, comprising a sleeve which is open on opposite outer ends and has an absorbent surface on an outer side thereof.
